(19) United States
(12) Patent Application Publication
(10) Pub. No.: US 2026/0212160 A1
(43) Pub. Date: Jul. 23, 2026

(54) MACHINE LEARNING BASED DYNAMIC PERFORMANCE PARAMETER SCALING

(71) Applicant: QUALCOMM Incorporated, San Diego, CA (US)

(72) Inventors: Siddhant GUPTA, San Diego, CA (US); Ninad PATGAONKAR, San Diego, CA (US); Nikhil Kumar KANSAL, San Diego, CA (US); Mustafa KESKIN, San Diego, CA (US)

(21) Appl. No.: 19/035,742

(22) Filed: Jan. 23, 2025

(51) Int. Cl. G06N 3/0455; G06N 3/08

(52) U.S. Cl. CPC G06N 3/0455; G06N 3/08

(57) ABSTRACT

Systems and techniques are described herein for data processing. For example, a computing device can determine to process performance data associated with at least one processor to generate an embedding. The computing device can process, using a machine learning model, the embedding to determine a prediction associated with a task to be performed by the at least one processor. The computing device can adjust performance parameters of the at least one processor based on the prediction.

### TECHNICAL FIELD

The present disclosure generally relates machine learning systems. For example, aspects of the disclosure relate to systems and techniques for machine learning based dynamic performance parameter scaling (e.g., adjusting clock voltage, frequency, cycle, and/or other parameters of a processor).

### BACKGROUND

Energy efficiency of devices can directly impact the usability and performance of the devices. For example, mobile devices can benefit from improvements to energy efficiency which can extend battery life allowing the mobile devices to be used for longer periods of time between charges. Energy efficiency can improve the usability of other devices, such as devices implementing machine learning models, by reducing energy consumption of various operations and tasks. Many devices or systems use power management techniques to conserve energy and power by adjusting processor performance parameters based on tasks or actions to be performed. For example, dynamic clock and voltage scaling (DCVS) and dynamic voltage and frequency scaling (DVFS) can be used to adjust clock, voltage, and frequency of a processor to reduce power consumption for lower computationally intensive tasks and to increase power consumption for higher computationally intensive tasks.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, an apparatus for data processing is provided. The apparatus includes a processing system configured to: process performance data associated with at least one processor to generate an embedding; process, using a machine learning model, the embedding to determine a prediction associated with a task to be performed by the at least one processor; and adjust performance parameters of the at least one processor based on the prediction.

In some aspects, a method for data processing is provided. The method includes: processing performance data associated with at least one processor to generate an embedding; processing, using a machine learning model, the embedding to determine a prediction associated with a task to be performed by the at least one processor; and adjusting performance parameters of the at least one processor based on the prediction.

In some aspects, a non-transitory computer-readable medium is provided having stored thereon instructions that, when executed by a processing system, cause the processing system to: process performance data associated with at least one processor to generate an embedding; process, using a machine learning model, the embedding to determine a prediction associated with a task to be performed by the at least one processor; and adjust performance parameters of the at least one processor based on the prediction.

In some aspects, an apparatus for data processing is provided. The apparatus includes: means for processing performance data associated with at least one processor to generate an embedding; means for processing, using a machine learning model, the embedding to determine a prediction associated with a task to be performed by the at least one processor; and means for adjusting performance parameters of the at least one processor based on the prediction. The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

FIG. 1 is a block diagram illustrating an architecture of an example system on a chip (SOC) for performing location modeling, according to aspects of the disclosure;

FIG. 2 is a block diagram illustrating an example machine learning model for adjusting performance parameters of a processor, according to aspects of the disclosure;

FIG. 3 is a block diagram illustrating an example transformer for adjusting performance parameters of a processor, according to aspects of the disclosure;

FIG. 4 is a block diagram illustrating an example of processing input data for a machine learning model, according to aspects of the disclosure;

FIG. 5 is a block diagram illustrating an example system for adjusting performance parameters of a processor;

FIG. 6 is a flow diagram for an example process for data processing, according to aspects of the disclosure;

FIG. 7 is a block diagram illustrating an example of a deep learning neural network that can be used to perform various tasks, according to aspects of the disclosure;

FIG. 8 is a block diagram illustrating an example of a convolutional neural network (CNN), according to aspects of the disclosure;

FIG. 9 is a block diagram of an example transformer, according to aspects of the disclosure; and

FIG. 10 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, energy efficiency of devices can directly impact the usability and performance of the devices. For example, mobile devices can benefit from improvements to energy efficiency which can extend battery life thereby improving usability of the device by allowing the mobile devices to be used for longer periods of time without charging. Energy efficiency can improve the usability of other devices, such as devices implementing machine learning models by reducing energy consumption of various machine learning model operations and tasks. Many devices or systems use power management techniques to conserve energy and power by adjusting processor performance based on tasks or actions to be performed. For example, dynamic clock and voltage scaling (DCVS) and dynamic voltage and frequency scaling (DVFS) can be used to adjust clock, voltage, and frequency of at least one processor to reduce power consumption for lower computationally intensive tasks and to increase power consumption for higher computationally intensive tasks.

Various algorithms for adjusting performance parameters of a processor (e.g., DCVS and DVFS) can be used to improve energy efficiency of the processor under different workloads. The various algorithms can adjust performance parameters (e.g., clock frequency, voltage, cycle, etc.) of a processor based on performance data of the processor. Performance data can include information indicating how efficiently or effectively a processor is performing actions under various workloads. Performance data can include information such as processor temperature data. Processor temperature data can indicate thermal efficiency of a processor and can indicate whether the processor is at risk of throttling when the processor is too hot to operate efficiently. Performance data can include clock frequency data of the processor. The clock frequency data can indicate processor speed in performing various tasks.

Performance data can further include power management integrated circuit (PMIC) voltage data indicating voltage (or power) provided by a PMIC to the processor during changes in workloads. For examples of performance data can include processor voltage levels, processor bandwidth data, instructions per second data indicating how many instructions are executed by the processor per clock cycle, and processor latency data indicating delays in task execution by the processor.

Machine learning models (e.g., artificial neural network models, transformer architectures, etc.) can be used to predict adjustments to performance parameters of a processor based on performance data of the processor. Current systems and devices rely on reactive algorithms (e.g., algorithms that adjust performance parameters based on current computational resource demands). Current algorithms, by being reactive, respond too late to change in computational resource demands of a processor. A late or inaccurate response to changes in computational resource demands can create inefficiencies in use of computational resources. For example, when transitioning between a computationally intensive operation to a lower computationally intensive operation of the processor can be inefficient as traditional DCVS techniques may maintain performance parameters at elevated frequencies or voltages despite reduced computational demands of the lower computationally intensive operation. Using a machine learning model to predict future computational resource demands based on performance data of a processor can allow for faster adjustment of performance parameters of a processor thereby conserving computational resources.

Systems, apparatuses, methods (also referred to as processes), and computer-readable media (collectively referred to herein as “systems and techniques”) are described herein that provide data processing using a machine learning model to predict future performance parameters (e.g., clock frequency, voltage, cycle, etc.) of a processor (or multiple processors) based on performance data of the processor(s). In some aspects, the systems and techniques can include adjusting performance parameters of the processor(s) based on the predictions. The predictions can be generated by a machine learning model such as a neural network or transformer architecture.

In some aspects, the systems and techniques can include tokenizing performance data associated with a processor. For example, the systems and techniques can include generating a plurality of tokens associated with the performance data. The plurality of tokens can be concatenated with additional tokens associated with performance data of the processor. In some aspects, the systems and techniques can include generating an embedding associated with the plurality of tokens. For example, the systems and techniques can include using an embedding layer of a machine learning model to generate an embedding associated with the performance data.

In some aspects, the performance data can include a processor temperature, clock frequency, power management integrated circuit (PMIC) voltage, processor voltage level, processor bandwidth, processor instructions per cycle, and processor latency. In some aspects, the systems and techniques can include tokenizing the performance data associated with the processor to generate the embedding using an input layer and embedding layer of the machine learning model. For example, the machine learning model can include a plurality of layers, such as an input layer and an embedding layer.

In some aspects, the systems and techniques can include applying positional encoding to an embedding or to the plurality of tokens. For example, the positional encoding can include information associated with position of tokens within the plurality of tokens. In some aspects, the positional encoding can include information associated with a position of values associated with the plurality of tokens within the embedding. In further aspects, the positional encoding can be included (e.g., appended to or concatenated with) in the embedding. In such an example, the positional encoding can be a rotary positional embedding (RoPE). For example, the positional encoding can be performed using the machine learning model (e.g., an encoder of the machine learning model).

In some aspects, the systems and techniques can include processing the embedding to determine a prediction associated with a task to be performed by the processor. In some aspects, the systems and techniques can include adjustments to the performance parameters includes scaling the performance parameters based on the prediction. For example, the prediction can be a scalar (e.g., a scaling vector) which can be applied to performance parameters of the processor. For example, the adjustments can be adjustments to voltage levels of the processor.

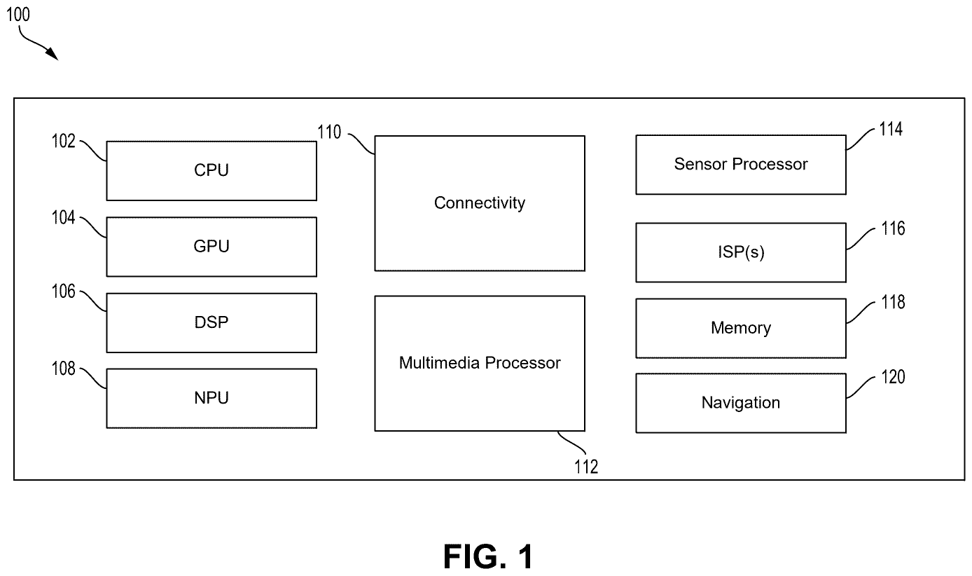

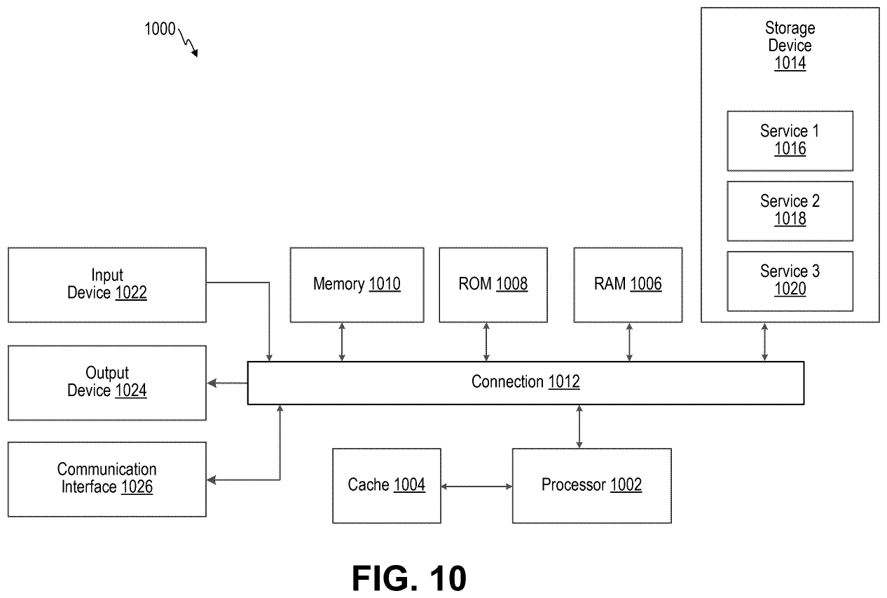

In some aspects, the systems and techniques described herein can be performed by a processing system (e.g., such as the SOC 100 of FIG. 1 or a component of the SOC 100, the computing architecture 1000 of FIG. 10 or a component of the computing architecture 1000, etc.). A processing system may include one or more components (or subcomponents), such as one or more components described herein. For example, a respective component of the one or more components may be, be similar to, include, or be included in at least one memory, at least one communication interface, and/or at least one processor. In some cases, the one or more components may include a first component, a second component, and/or a third component. In one illustrative example, the processing system can include the first component and the second component, where the first component may be coupled to the second component. In this example, the first component may be at least one processor and the second component may be at least one memory. In another illustrative example, the processing system can include the first component, the second component, and the third component, where the first component may be coupled to the second component and the third component. In this example, the first component may be at least one processor, the second component may be at least one memory, and the third component may be a communication interface.

A processing system may generally be a system including one or more components that may perform one or more functions, such as any function or combination of functions described herein. For example, one or more components (e.g., at least one communication interface) may receive input information (e.g., any information that is an input, such as a signal, any digital information, or any other information), one or more components (e.g., at least one processor) may process the input information to generate output information (e.g., any information that is an output, such as a signal or any other information), one or more components (e.g., at least one memory) may store information (e.g., the processed input information), one or more components may perform any other function(s) as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, one or more devices described herein.

For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a device described herein may interface with one or more other components of the device, may process information received from one or more other components (such as input information), or may output information to one or more other components. For example, a processing system may include a first component configured to interface with one or more other components of the device to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip (e.g., a chipset, a system-on-chip (SoC), modem, etc.) of the device may include a processing system. The processing system may include a first communication interface to receive or obtain information, and a second communication interface to output, transmit, and/or otherwise provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

Various aspects of the application will be described with respect to the figures below.

FIG. 1 illustrates an example implementation of a system-on-a-chip (SOC) 100, which can include a central processing unit (CPU) 102 or a multi-core CPU, configured to perform one or more of the functions described herein. Parameters or variables (e.g., neural signals and synaptic weights), system parameters associated with a computational device (e.g., artificial neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 can also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

In some cases, the SOC 100 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles can benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer can be referred to as feedback (or top-down) connection. A network with many feedback connections may be helpful when the recognition of a high-level concept may aid in discriminating the particular low-level features of an input. The connections between layers of a neural network may be fully connected or locally connected.

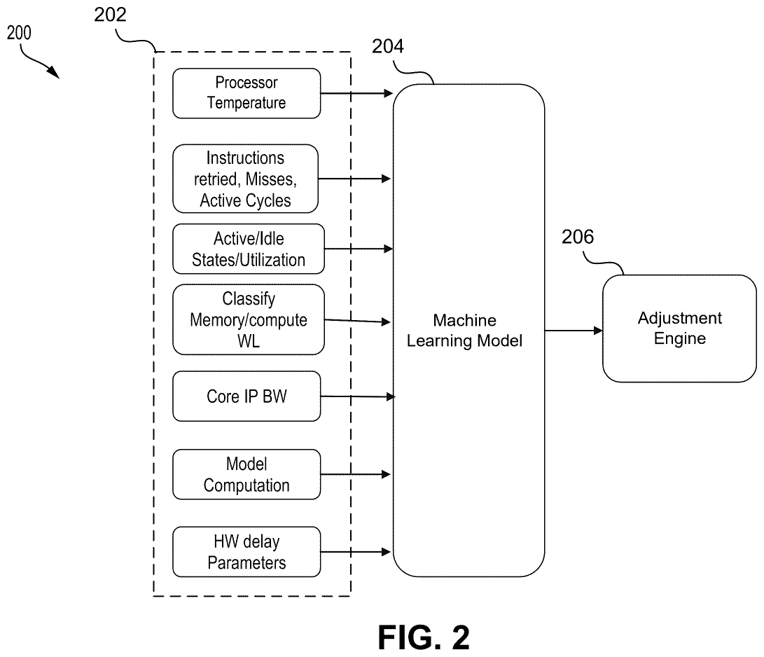

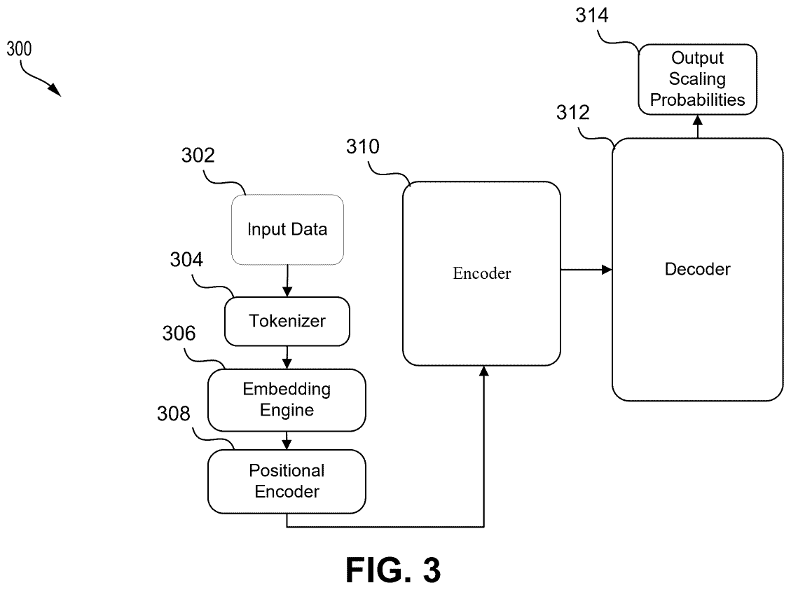

In some aspects, the SOC 100 of FIG. 1 can process data using neural networks and/or machine learning (ML) systems such as the machine learning model 204 of FIG. 2 and the transformer 300 of FIG. 3.

FIG. 2 is a block diagram 200 illustrating an example machine learning model 204 to determine performance parameter adjustments. The block diagram 200 includes input data 202, a machine learning model 204, and an adjustment engine 206.

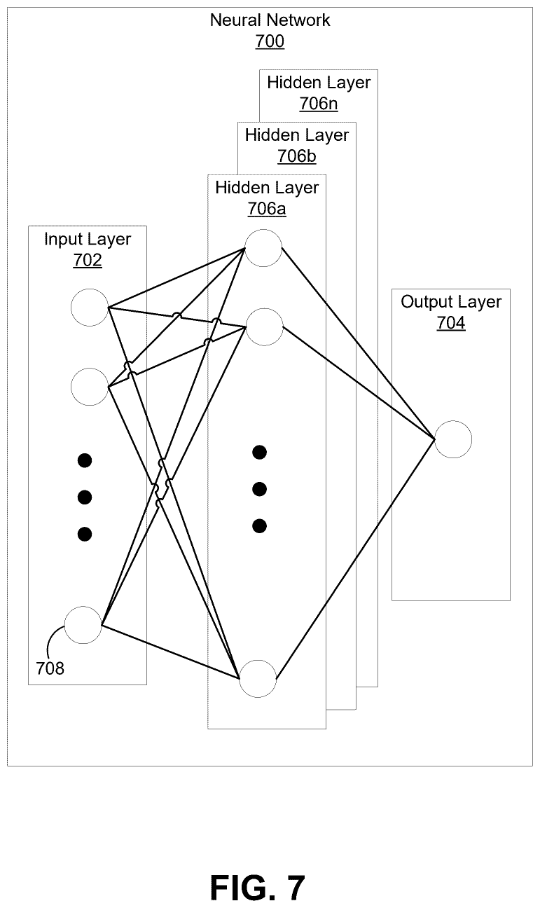

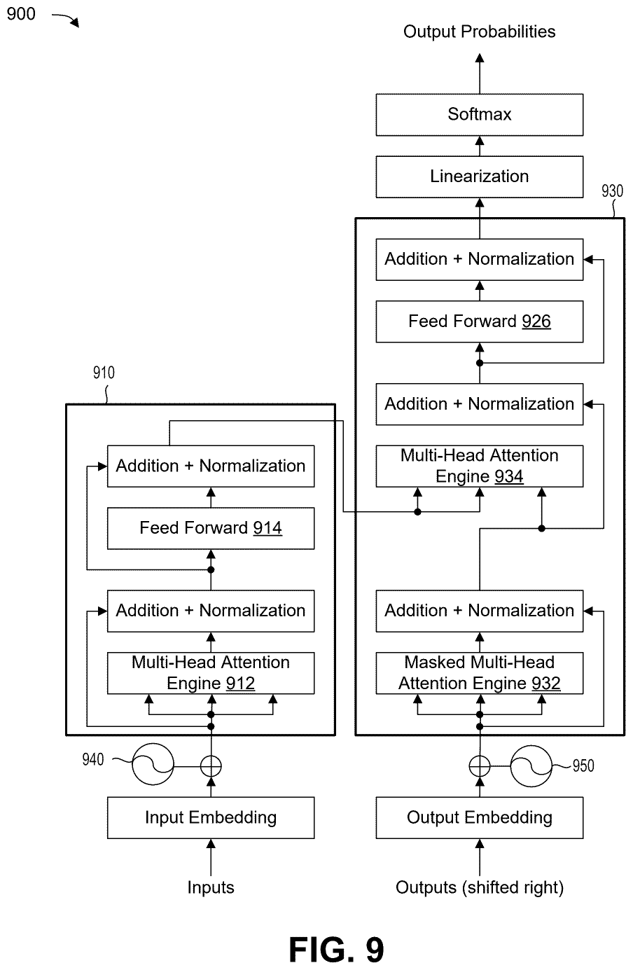

The machine learning model 204 can be a neural network (e.g., the neural network 700 of FIG. 7) or transformer architecture (e.g., the transformer 300 of FIG. 3, the transformer 900 of FIG. 9, etc.). The machine learning model 204 can receive input data 202 to generate predictions based on the input data 202. The predictions can include predictions of tasks to be performed by a processor. In some examples, the predictions can include predicted adjustments to the performance parameters of the processor. For example, the machine learning model 204 can determine, based on input data 202, a task to be performed by the processor and performance parameters associated with the task which can conserve computing resources of the processor. In one such example, the machine learning model 204 can determine, based on a predicted task, whether to adjust a voltage level or clock frequency of the processor to conserve power when performing the predicted task.

The machine learning model 204 can output the adjustments to the performance parameters to the adjustment engine 206. The adjustment engine 206 can apply the adjustments to the performance parameters of the processor. For example, the adjustment can be a change in voltage of the processor, or a change in clock cycle of the processor. For example, the input data can be vectors of data. In further examples, the input data 202 can be tokens. In such an example, the input data 202 can include tokenized representations (e.g., tokens or a plurality of tokens) associated with the performance data.

For example, the machine learning model 204 can include a tokenizer to generate a plurality of tokens based on the input data 202. In some examples, the input data 202 can be concatenated. In such an example, an embedding can be generated based on the concatenated input data 202. The embedding can be used by the machine learning model 204 to generate adjustments to performance parameters. In some examples, the embedding can include positional encoding. For example, the embedding layer (or another layer of the machine learning model) can receive the embedding or the plurality of tokens as a sequence of values. The embedding layer (or another layer of the machine learning model 204) can generate values representing the position of tokens within the sequence. The values representing the position can be appended to or concatenated with the plurality of tokens or the embedding. Various positional encoding techniques can be used in the embedding layer (or another layer of the machine learning model 204) such as RoPE functions, index-based positional encoding, sinusoidal positional encoding, etc. include a RoPE function. In one such example, the machine learning model 204 can apply a RoPE function to a plurality of tokens (or the embedding) to append or concatenate positional values representing with the position of tokens within the plurality of tokens. The machine learning model 204 can receive the plurality of tokens (or the embedding) including the positional values as inputs at an input layer of the machine learning model 204.

In some examples, the input data 202 can include vectors of data associated with performance of a processor (e.g., performance data). For example, the input data 202 can include information indicating how efficiently or effectively a processor is performing actions under various workloads. For example, the input data 202 can include processor temperature data. Processor temperature data can indicate thermal efficiency of a processor and can indicate whether the processor is at risk of throttling when the processor is too hot to operate efficiently. Input data 202 can further include clock frequency data of the processor, PMIC voltage data, processor bandwidth data, instructions per second data indicating how many instructions are executed by the processor per clock cycle, and processor latency data indicating delays in task execution by the processor. In another example, the input data 202 can include state information associated with a state of the processor (e.g., whether the processor is in an idle state, active state, etc.). The input data 202 can further include information associated with capabilities of the processor, such as memory bandwidth of the processor, hardware delay parameters, etc. In a further example, the input data 202 can include data associated with user behavior. For example, the input data 202 can include past operations or tasks requested by the user to be performed using the processor.

The machine learning model 204 can generate predictions associated with adjustments to performance parameters of the processor. For example, the adjustments can be changes to voltage, clock frequency, and clock periods of a processor. The adjustment engine 206 can apply the adjustments to the processor. The predictions can represent a prediction of performance parameters to be used by the processor to perform an operation. In one non-limiting example, the machine learning model 204 can determine based on the input data 202, that the processor should be set at a lower clock frequency and voltage to lower the processor temperature to avoid throttling the processor when performing an operation. In another example, the machine learning model 204 can determine based on the input data 202 to increase processor voltage and clock frequency for computationally intensive operations and tasks.

In some aspects, training of the machine learning model 204 (or the other machine learning models, neural networks, transformers, etc.) described herein can be performed using online training (e.g., in some case on-device training), offline training, and/or various combinations of online and offline training. In some cases, online may refer to time periods during which the input data (e.g., performance data associated with a processor, etc.) is processed, for instance for adjusting performance parameters performance of augmenting the training audio signal implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

FIG. 3 is a block diagram illustrating an example machine learning model using transformer architecture (e.g., transformer 300) for adjusting performance parameters of a processor. The transformer 300 includes input data 302, a tokenizer 304, an embedding engine 306, a positional encoder 308, an encoder 310, a decoder 312, and output scaling probabilities 314.

The transformer 300 can receive input data 302 at an input layer (or another layer) of the transformer 300. The input data 302 can include performance data associated with operation of a processor. For example, the input data 302 can include data such as processor temperature data, memory bandwidth, clock cycle of the processor, voltage level of the processor, state of the processor (e.g., idle, active), etc.

The input data 302 can be represented as vectors of data. For example, the input data 302 can include a first vector associated with processor temperature data, a second vector associated memory bandwidth of the processor, a third vector associated with clock cycle of the processor, etc. In some examples, the input data 302 can be quantized and normalized. For example, the input data 302 can be floating point values. The transformer 300 can include a normalization or quantization layer to normalize and quantize the input data 302.

The tokenizer 304 can process the input data 302 to generate tokenized representations (e.g., plurality of tokens) of the input data 302. The embedding engine 306 can process the plurality of tokens to generate an embedding representation of the plurality of tokens. In some examples, the embedding representation can be represented as a sequence of tokens or values. The sequence of tokens can be concatenated representations of the input data 302 (e.g., concatenations of tokens associated with various vectors of input data).

The embedding can be received by the positional encoder 308. The positional encoder 308 can perform various positional encoding techniques (e.g., RoPE functions, index-based encoding, etc.) to determine relationships between values of the embedding based on positions of values within the embedding. The positional encoder 308 can generate various positional values associated with the relationships. The positional values can be appended to the embedding or concatenated with the embedding.

The embedding including the positional values can be received by the encoder 310. The encoder 310 can include one or more multi-head attention layers (or multi-head and single and feed forward networks. The encoder 310 can use multi-head attention and self-attention layers to determine relationships between values (or tokens) of the embedding (e.g., the embedding including positional values). For example, the multi-header attention and self-attention layers can use scaled dot-product attention to determine vectors associated queries, keys, and values of a layer of the encoder 310.

In some examples, the embedding can include a set of values associated with positions of tokens within the embedding. In another example, the tokenizer 304, embedding engine 306, or the positional encoder 308, can process the input data 302 by sorting the input data 302 (or portions of the input data 302) into levels based on a magnitude (or other characteristics) of the input data 302. The input data 302 can be tokenized, normalized, and quantized based on the levels (e.g., by the tokenizer 304, embedding engine 306, or the positional encoder 308).

The output of the multi-head attention and self-attention layer (or layers) can be provided to a feed-forward layer (also referred to as a feed-forward neural network) to apply linear transformations to the output. Further description of multi-head attention and feed-forward neural networks is provided in the description of FIG. 10.

The output of the encoder 310 can include a sequence of embeddings representing relationships between values (e.g., relationships between values of the input data 302). The decoder 312 can process the sequence of embeddings to generate a prediction of the associated with a task or operation to be performed by the processor. For example, the prediction can be a probability representation that the processor should perform an operation (e.g., output scaling probabilities 314). In such an example, the prediction can be a probability associated with whether the processor should transition to an idle state and reduce clock cycle and voltage. The output scaling probabilities can be used by the processor to adjust performance metrics of the processor (e.g., to adjust parameters such as clock frequency, processor voltage level, etc.).

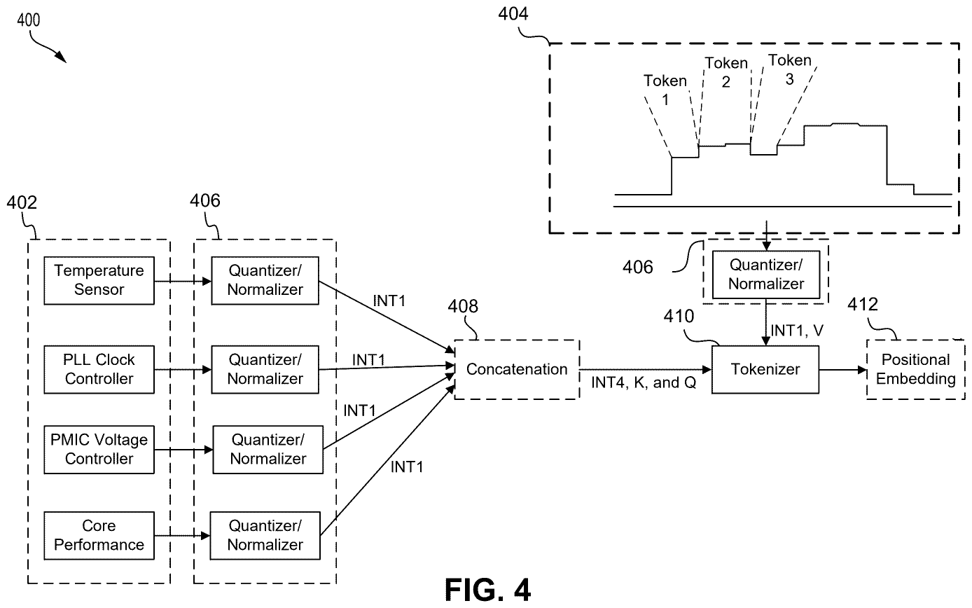

FIG. 4 is a block diagram 400 illustrating an example of tokenization of input data to be processed using a machine learning model (e.g., the machine learning model 204 of FIG. 2, the transformer 300 of FIG. 3, etc.). FIG. 4 includes input data 402 and 404, quantizers 406, and tokenizer 410. In some examples, FIG. 4 can concatenate the outputs of the quantizers 406 (e.g., at block 408) and apply positional embeddings (e.g., at block 412) to the output of the tokenizer 410.

The input data 402 and 404 can include performance data associated with operation of a processor. For example, the input data 402 can include processor temperature, phase lock loop (PLL) clock of the processor, PMIC voltage, and performance data associated with cores of the processor. Input data 404 includes voltage levels of the processor. The individual voltage levels of the processor can be quantized and tokenized by the tokenizer 410. For example, the voltage levels of the processor can be represented as tokens (e.g., each voltage level of the processor can be represented as a token within a sequence of tokens). In some examples, the tokens associated with the voltage levels of the processor can be concatenated with the tokens associated with input data 402.

The input data 402 and 404 can be quantized and normalized using the quantizers 406. For example, the input data can be analog information or floating point data. The quantizers 406 can convert the analog information or floating point data into integers. The quantized input data associated with input data 402 can be concatenated to generate a sequence of input data. The concatenated input data from block 408 and the quantized input data associated with voltage levels of the processor can be received by the tokenizer 410. The tokenizer can generate a plurality of tokens associated with the sequence of input data and the quantized input data associated with voltage levels of the processor. In some examples, the output of the tokenizer 410 can include an embedding representation of quantized input data.

An encoder can apply positional embeddings (e.g., represented at block 412) to the plurality of tokens. For example, the positional embedding can be generated by applying the plurality of tokens (or the embedding) to a RoPE function. In such an example, the positional embedding can be appended to or concatenated with the plurality of tokens (or the embedding). The output of the encoder can be received by an input layer of a machine learning model (e.g., the machine learning model 204 of FIG. 2 or the transformer 300 of FIG. 3) to generate adjustments to performance parameters of a processor.

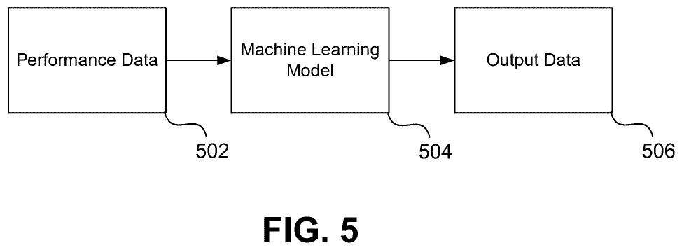

FIG. 5 is a block diagram illustrating an example system 500 system for adjusting performance parameters. The system 500 includes performance data 502, a machine learning model 504, and output data 506.

The performance data 502 can be associated with operation of a processor using adjusted performance parameters. For example, the performance data 502 can be the performance data of a processor using the transformer 300 of FIG. 3 to adjust performance parameters of the processor. In another example, the performance data 502 can be the performance data of a processor using various DCVS or DVFS techniques.

The machine learning model 504 can generate output scaling probabilities (e.g., output data 506) based on the performance data 502. For example, the machine learning model 504 can be a long short-term memory (LSTM) or other recurrent neural network (RNN). The machine learning model 504 can process the performance data 502 to generate output scaling probabilities representing predictions of whether the processor should perform an operation. In some examples, the machine learning model 504 can output scaling values associated with the output scaling probabilities which can be used to adjust performance parameters of the processor. In some examples, the machine learning model 504 can be fine-tuned based benchmarks of the processor (e.g., the processor to which performance parameters are to be adjusted). For example, the machine learning model 504 can be fine-tuned based on a comparison of benchmarks associated with performance data using various DCVS techniques and benchmarks associated with performance data using output scaling probabilities to adjust performance parameters of the processor. In another example, memory or computational constrained devices (e.g., mobile devices) can use a machine learning model trained off device (e.g., in offline training on a server or other external device) and a pruned version of the machine learning model (e.g., a machine learning model with lower computational restraints such as reduced architecture or reduced resolution). The machine learning model and pruned machine learning model can be retrained as a second stage on device with various DCVS algorithms or techniques as a first stage for fine-tuning. The retrained machine learning models can be use for inferences using the constrained device.

In some examples, the machine learning model 504 can include a transformer architecture. For example, the machine learning model can be a large language model (LLM) using cross-attention of performance parameters of a device or a processor associated with the performance data 502.

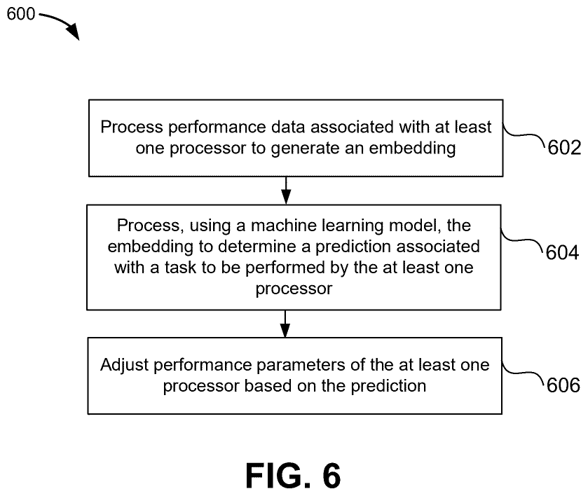

FIG. 6 is a flow diagram illustrating an example process 600 for data processing, in accordance with aspects of the present disclosure. One or more operations of process 600 can be performed by a computing device (or apparatus) or a component (e.g., the SOC 100 of FIG. 1, the computing architecture 1000 of FIG. 10, one or more chipsets, one or more processors such as one or more central processing units (CPUs), digital signal processors (DSPs), neural processing units (NPUs), neural signal processors (NSPs), microcontrollers, application specific integrated circuits (ASICs), field programmable logic arrays (FPGAs), programmable logic devices, discrete gates or transistor logic components, discrete hardware components, etc., an ML system such as a neural network model, any combination thereof, and/or other component or system) of the computing device. The computing device can be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 600. The one or more operations of process 600 can be implemented as software components that are executed and run on one or more processors.

At block 602, the computing device (or component thereof) can process performance data associated with at least one processor to generate an embedding. For example, the computing device can be a processor or processing system. In such an example, the performance data can include information associated with operation of a processor or processing system. For example, the performance data can include at least one of a processor temperature, a clock frequency, a power management integrated circuit (PMIC) voltage, a processor voltage level, a processor bandwidth, a processor instructions per cycle, or a processor latency. In some examples, processing the performance data can include quantizing and normalizing the performance data. In some examples, the computing device can generate the embedding using an input layer and an embedding layer of a machine learning model (such as the machine learning model used to process the embedding). In further examples, the embedding can a set of values associated with one or more positions of tokens within the embedding. For example, the set of values can be positional encodings, such as the positional encodings output by a positional encoder (e.g., the positional encoder 308 of FIG. 3). The set of values can indicate positions of tokens within the embedding in relation to the positions of other tokens of the embedding.

In some aspects, the processed performance data can be sorted into levels based on performance data values (e.g., sorted based on magnitude of the data values or based on relationships between the data values). In such an example, the performance data values can be tokenized, normalized, quantized, and arranged in the embedding based on the levels. In another example, the performance data can be concatenation of different types of performance data from various sensors, the processor, etc. For example, the performance data can include a concatenation of data associated with a temperature of the at least one processor, a phase and frequency of the at least one processor, and a power management integrated circuit (PMIC) voltage.

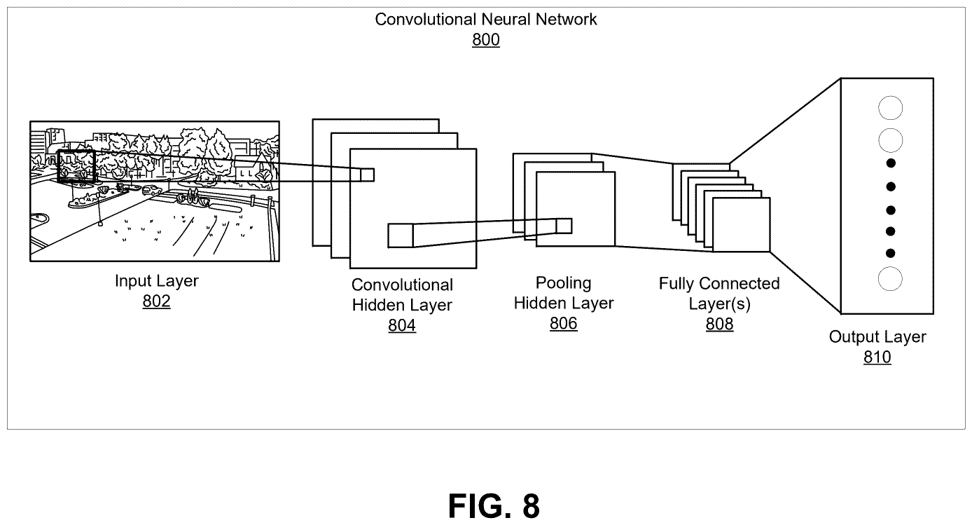

At block 604, the computing device (or component thereof) can process, using a machine learning model, the embedding to determine a prediction associated with a task to be performed by the at least one processor. For example, the computing device can use a machine learning model to process the performance data (e.g., the machine learning model 204 of FIG. 2, the encoder 310 and decoder 312 of FIG. 3, the machine learning model 504 of FIG. 5, the neural network 700 of FIG. 7, the CNN 800 of FIG. 8, the transformer 900 of FIG. 9, etc.) to determine the prediction associated with the task to be performed by the at least one processor. In some examples, the machine learning model can use transformer architecture. In such an example, the machine learning model can include a large language model (LLM). The LLM can use cross-attention of the performance parameters. In such an example, the performance parameters can be associated with a current workload of the at least one processor.

In some aspects, the machine learning model can be trained using hardware delay parameters associated with the at least one processor (e.g., time delays associated with various operations of the processor). In another example, the machine learning model can be trained using on-device training.

At block 606, the computing device (or component thereof) can adjust performance parameters of the at least one processor based on the prediction. In some examples, the performance parameters can be parameters of a separate device or processor (e.g., different from the computing device adjusting the performance parameters). In some examples, the performance parameters include parameters associated with operation of a processor or computing device such as at least one of a clock frequency of the at least one processor, a voltage level of the at least one processor, or a cycle time period of the at least one processor. In some examples, adjusting the performance parameters can include scaling the performance parameters based on the prediction.

As noted previously one or more of the systems and techniques described herein can be implemented using a neural network. FIG. 7 is an illustrative example of a neural network 700 (e.g., a deep-learning neural network) that can be used to implement machine-learning based location modeling via autoregressive decoding, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 700 can be an example of, or can implement, the machine learning model 204 of FIG. 2, the encoder 310 and the decoder 312 of FIG. 3, etc.

An input layer 702 includes input data. In one illustrative example, input layer 702 can include data representing input data associated with the input data 202 of FIG. 2. Neural network 700 includes multiple hidden layers, for example, hidden layers 706a, 706b, through 706n. The hidden layers 706a, 706b, through hidden layer 706n include “n” number of hidden layers, where “n” is an integer greater than or equal to one. The number of hidden layers can be made to include as many layers as needed for the given application. Neural network 700 further includes an output layer 704 that provides an output resulting from the processing performed by the hidden layers 706a, 706b, through 706n. In one illustrative example, output layer 704 can generate predictions of adjustments to performance parameters of a processor, such as the output scaling probabilities 314 of FIG. 3.

Neural network 700 can be or can include a multi-layer neural network of interconnected nodes. Each node can represent a piece of information. Information associated with the nodes is shared among the different layers and each layer retains information as information is processed. In some cases, neural network 700 can include a feed-forward network, in which case there are no feedback connections where outputs of the network are fed back into itself. In some cases, neural network 700 can include a recurrent neural network, which can have loops that allow information to be carried across nodes while reading in input.

Information can be exchanged between nodes through node-to-node interconnections between the various layers. Nodes of input layer 702 can activate a set of nodes in the first hidden layer 706a. For example, as shown, each of the input nodes of input layer 702 is connected to each of the nodes of the first hidden layer 706a. The nodes of first hidden layer 706a can transform the information of each input node by applying activation functions to the input node information. The information derived from the transformation can then be passed to and can activate the nodes of the next hidden layer 706b, which can perform their own designated functions. Example functions include convolutional, up-sampling, data transformation, and/or any other suitable functions. The output of the hidden layer 706b can then activate nodes of the next hidden layer, and so on. The output of the last hidden layer 706n can activate one or more nodes of the output layer 704, at which an output is provided. In some cases, while nodes (e.g., node 708) in neural network 700 are shown as having multiple output lines, a node has a single output and all lines shown as being output from a node represent the same output value.

In some cases, each node or interconnection between nodes can have a weight that is a set of parameters derived from the training of neural network 700. Once neural network 700 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 700 to be adaptive to inputs and able to learn as more and more data is processed.

Neural network 700 may be pre-trained to process the features from the data in the input layer 702 using the different hidden layers 706a, 706b, through 706n in order to provide the output through the output layer 704. In an example in which neural network 700 is used to identify features in images, neural network 700 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 700 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 700 is trained well enough so that the weights of the layers are accurately tuned.

For the example of identifying objects in images, the forward pass can include passing a training image through neural network 700. The weights are initially randomized before neural network 700 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 700, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 700 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 700 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−η dL/dW, where w denotes a weight, wᵢ denotes the initial weight, and η denotes a learning rate. The learning rate can be set to any suitable value, with a high learning rate including larger weight updates and a lower value indicating smaller weight updates.

Neural network 700 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 700 can include any other deep network other than a CNN, such as an autoencoder, a deep belief nets (DBNs), a Recurrent Neural Networks (RNNs), among others.

FIG. 8 is an illustrative example of a convolutional neural network (CNN) 800. The input layer 802 of the CNN 800 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 804, an optional non-linear activation layer, a pooling hidden layer 806, and fully connected layer 808 (which fully connected layer 808 can be hidden) to get an output at the output layer 810. While only one of each hidden layer is shown in FIG. 8, one of ordinary skill will appreciate that multiple convolutional hidden layers, non-linear layers, pooling hidden layers, and/or fully connected layers can be included in the CNN 800. As previously described, the output can indicate a single class of an object or can include a probability of classes that best describe the object in the image.

The first layer of the CNN 800 can be the convolutional hidden layer 804. The convolutional hidden layer 804 can analyze image data of the input layer 802. Each node of the convolutional hidden layer 804 is connected to a region of nodes (pixels) of the input image called a receptive field. The convolutional hidden layer 804 can be considered as one or more filters (each filter corresponding to a different activation or feature map), with each convolutional iteration of a filter being a node or neuron of the convolutional hidden layer 804. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 804. Each connection between a node and a receptive field for that node learns a weight and, in some cases, an overall bias such that each node learns to analyze its particular local receptive field in the input image. Each node of the convolutional hidden layer 804 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 804 is due to each node of the convolutional layer being applied to its corresponding receptive field. For example, a filter of the convolutional hidden layer 804 can begin in the top-left corner of the input image array and can convolve around the input image. As noted above, each convolutional iteration of the filter can be considered a node or neuron of the convolutional hidden layer 804. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 804. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 804.

The mapping from the input layer to the convolutional hidden layer 804 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 804 can include several activation maps in order to identify multiple features in an image. The example shown in FIG. 8 includes three activation maps. Using three activation maps, the convolutional hidden layer 804 can detect three different kinds of features, with each feature being detectable across the entire image.

In some examples, a non-linear hidden layer can be applied after the convolutional hidden layer 804. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 800 without affecting the receptive fields of the convolutional hidden layer 804.

The pooling hidden layer 806 can be applied after the convolutional hidden layer 804 (and after the non-linear hidden layer when used). The pooling hidden layer 806 is used to simplify the information in the output from the convolutional hidden layer 804. For example, the pooling hidden layer 806 can take each activation map output from the convolutional hidden layer 804 and generates a condensed activation map (or feature map) using a pooling function. Max-pooling is one example of a function performed by a pooling hidden layer. Other forms of pooling functions be used by the pooling hidden layer 806, such as average pooling, L2-norm pooling, or other suitable pooling functions. A pooling function (e.g., a max-pooling filter, an L2-norm filter, or other suitable pooling filter) is applied to each activation map included in the convolutional hidden layer 804. In the example shown in FIG. 8, three pooling filters are used for the three activation maps in the convolutional hidden layer 804.

In some examples, max-pooling can be used by applying a max-pooling filter (e.g., having a size of 2×2) with a stride (e.g., equal to a dimension of the filter, such as a stride of 2) to an activation map output from the convolutional hidden layer 804. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 804 having a dimension of 24×24 nodes, the output from the pooling hidden layer 806 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. Discarding the exact positional information can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 800.

The final layer of connections in the network is a fully connected layer that connects every node from the pooling hidden layer 806 to every one of the output nodes in the output layer 810. Using the example above, the input layer includes 28×28 nodes encoding the pixel intensities of the input image, the convolutional hidden layer 804 includes 3×24×24 hidden feature nodes based on application of a 5×5 local receptive field (for the filters) to three activation maps, and the pooling hidden layer 806 includes a layer of 3×12×12 hidden feature nodes based on application of max-pooling filter to 2×2 regions across each of the three feature maps. Extending such an example, the output layer 810 can include ten output nodes. In such an example, every node of the 3×12×12 pooling hidden layer 806 is connected to every node of the output layer 810.

The fully connected layer 808 can obtain the output of the previous pooling hidden layer 806 (which should represent the activation maps of high-level features) and determines the features that most correlate to a particular class. For example, the fully connected layer 808 can determine the high-level features that most strongly correlate to a particular class and can include weights (nodes) for the high-level features. A product can be computed between the weights of the fully connected layer 808 and the pooling hidden layer 806 to obtain probabilities for the different classes. For example, if the CNN 800 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 810 can include an M-dimensional vector (in the prior example, M=10). M indicates the number of classes that the CNN 800 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 9 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 900 reduces the operations of learning dependencies by using an encoder 910 and a decoder 930 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 910 is composed of a stack of six identical layers and each layer has two sub-layers. The first sub-layer is a multi-head self-attention engine 912, and the second sub-layer is a fully-connected feed-forward network 914. A residual connection (not shown) connects around each of the sub-layers followed by normalization.

In the example transformer 900, the decoder 930 is also composed of a stack of six 6 identical layers. The decoder also includes a masked multi-head self-attention engine 932, a multi-head attention engine 934 over the output of the encoder 910, and a fully-connected feed-forward network 926. Each layer includes a residual connection (not shown) around the layer, which is followed by layer normalization. The masked multi-head self-attention engine 932 is masked to prevent positions from attending to subsequent positions and ensures that the predictions at position i can depend only on the known outputs at positions less than i (e.g., auto-regression). In some cases, such auto-regression can be utilized in the sequential training/learning described with respect to the systems and techniques described herein (e.g., with respect to FIG. 5).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 940 to encode positions because the model does not contain recurrence and convolution, and relative or absolute position of the tokens is needed. In the transformer 900, the positional encodings are added to the input embeddings at the bottom layer of the encoder 910 and the decoder 930. The positional encodings are summed with the embeddings because the positional encodings and embeddings have the same dimensions. A corresponding position decoder 950 is configured to decode the positions of the embeddings for the decoder 930.

In some aspects, the transformer 900 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 900 can process input sequences of variable length, making it well-suited for natural language processing tasks where input lengths can vary greatly. Additionally, the self-attention mechanism allows the transformer 900 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 10 illustrates an example computing-device architecture 1000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1000 can include, implement, or be included in any or all of system and/or other devices, or modules described herein. Additionally, or alternatively, computing-device architecture 1000 may be configured to perform process 600, and/or other process described herein.

The components of computing-device architecture 1000 are shown in electrical communication with each other using connection 1012, such as a bus. The example computing-device architecture 1000 includes a processing unit (CPU or processor) 1002 and computing device connection 1012 that couples various computing device components including computing device memory 1010, such as read only memory (ROM) 1008 and random-access memory (RAM) 1006, to processor 1002.

Computing-device architecture 1000 can include a cache of high-speed memory connected directly with, in close proximity to, or integrated as part of processor 1002. Computing-device architecture 1000 can copy data from memory 1010 and/or the storage device 1014 to cache 1004 for quick access by processor 1002. In this way, the cache can provide a performance boost that avoids processor 1002 delays while waiting for data. These and other modules can control or be configured to control processor 1002 to perform various actions. Other computing device memory 1010 may be available for use as well. Memory 1010 can include multiple different types of memory with different performance characteristics. Processor 1002 can include any general-purpose processor and a hardware or software service, such as service 1 1016, service 2 1018, and service 3 1020 stored in storage device 1014, configured to control processor 1002 as well as a special-purpose processor where software instructions are incorporated into the processor design. Processor 1002 may be a self-contained system, containing multiple cores or processors, a bus, memory controller, cache, etc. A multi-core processor may be symmetric or asymmetric.

To enable user interaction with the computing-device architecture 1000, input device 1022 can represent any number of input mechanisms, such as a microphone for speech, a touch-sensitive screen for gesture or graphical input, keyboard, mouse, motion input, speech and so forth. Output device 1024 can also be one or more of a number of output mechanisms known to those of skill in the art, such as a display, projector, television, speaker device, etc. In some instances, multimodal computing devices can enable a user to provide multiple types of input to communicate with computing-device architecture 1000. Communication interface 1026 can generally govern and manage the user input and computing device output. There is no restriction on operating on any particular hardware arrangement and therefore the basic features here may easily be substituted for improved hardware or firmware arrangements as they are developed.

Storage device 1014 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1006, read only memory (ROM) 1008, and hybrids thereof. Storage device 1014 can include services 1016, 1018, and 1020 for controlling processor 1002. Other hardware or software modules are contemplated. Storage device 1014 can be connected to the computing device connection 1012. In one aspect, a hardware module that performs a particular function can include the software component stored in a computer-readable medium in connection with the necessary hardware components, such as processor 1002, connection 1012, output device 1024, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for data processing, the apparatus comprising: a processing system configured to: process performance data associated with at least one processor to generate an embedding; process, using a machine learning model, the embedding to determine a prediction associated with a task to be performed by the at least one processor; and adjust performance parameters of the at least one processor based on the prediction.
Aspect 2. The apparatus of Aspect 1, wherein the performance parameters include at least one of a clock frequency of the at least one processor, a voltage level of the at least one processor, or a cycle time period of the at least one processor.
Aspect 3. The apparatus of any of Aspects 1 to 2, wherein, to adjust the performance parameters, the processing system is configured to scale the performance parameters based on the prediction.
Aspect 4. The apparatus of any of Aspects 1 to 3, wherein the processing system is configured to: process the performance data associated with the at least one processor to generate the embedding using an input layer and an embedding layer of the machine learning model.
Aspect 5. The apparatus of any of Aspects 1 to 4, wherein the performance data includes at least one of a processor temperature, a clock frequency, a power management integrated circuit (PMIC) voltage, a processor voltage level, a processor bandwidth, a processor instructions per cycle, or a processor latency.
Aspect 6. The apparatus of any of Aspects 1 to 5, wherein the processed performance data is quantized and normalized.
Aspect 7. The apparatus of any of Aspects 1 to 6, wherein the embedding includes a set of values associated with one or more positions of tokens within the embedding.
Aspect 8. The apparatus of any of Aspects 1 to 7, wherein the processing system is configured to: process the performance data associated with the at least one processor to generate the embedding, wherein the processed performance data is sorted into levels based on performance data values and the performance data values are tokenized, normalized, and quantized based on the levels.
Aspect 9. The apparatus of any of Aspects 1 to 8, wherein the machine learning model is a transformer.
Aspect 10. The apparatus of any of Aspects 1 to 9, wherein the transformer is a large language model (LLM) using cross-attention of the performance parameters, wherein the performance parameters are associated with a current workload of the at least one processor.
Aspect 11. The apparatus of any of Aspects 1 to 10, wherein the performance data includes a concatenation of data associated with a temperature of the at least one processor, a phase and frequency of the at least one processor, and a power management integrated circuit (PMIC) voltage.
Aspect 12. The apparatus of any of Aspects 1 to 11, wherein the machine learning model is trained using hardware delay parameters associated with the at least one processor.
Aspect 13. The apparatus of any of Aspects 1 to 12, wherein the machine learning model is trained using on device training.
Aspect 14. A method for data processing, the method comprising: processing performance data associated with at least one processor to generate an embedding; processing, using a machine learning model, the embedding to determine a prediction associated with a task to be performed by the at least one processor; and adjusting performance parameters of the at least one processor based on the prediction.
Aspect 15. The method of Aspect 14, wherein the performance parameters include at least one of a clock frequency of the at least one processor, a voltage level of the at least one processor, or a cycle time period of the at least one processor.
Aspect 16. The method of any of Aspects 14 to 15, wherein, to adjust the performance parameters, the processing system is configured to scale the performance parameters based on the prediction.
Aspect 17. The method of any of Aspects 14 to 16, further comprising: processing the performance data associated with the at least one processor to generate the embedding using an input layer and an embedding layer of the machine learning model.
Aspect 18. The method of any of Aspects 14 to 17, wherein the performance data includes at least one of a processor temperature, a clock frequency, a power management integrated circuit (PMIC) voltage, a processor voltage level, a processor bandwidth, a processor instructions per cycle, or a processor latency.
Aspect 19. The method of any of Aspects 14 to 18, wherein the processed performance data is quantized and normalized.
Aspect 20. The method of any of Aspects 14 to 19, wherein the embedding includes a set of values associated with one or more positions of tokens within the embedding.
Aspect 21. The method of any of Aspects 14 to 20, the method further comprising: processing the performance data associated with the at least one processor to generate the embedding, wherein the processed performance data is sorted into levels based on performance data values and the performance data values are tokenized, normalized, and quantized based on the levels.
Aspect 22. The method of any of Aspects 14 to 21, wherein the machine learning model is a transformer.
Aspect 23. The method of any of Aspects 14 to 22, wherein the transformer is a large language model (LLM) using cross-attention of the performance parameters, wherein the performance parameters are associated with a current workload of the at least one processor.
Aspect 24. The method of any of Aspects 14 to 23, wherein the performance data includes a concatenation of data associated with a temperature of the at least one processor, a phase and frequency of the at least one processor, and a power management integrated circuit (PMIC) voltage.
Aspect 25. The method of any of Aspects 14 to 24, wherein the machine learning model is trained using hardware delay parameters associated with the at least one processor.
Aspect 26. The method of any of Aspects 14 to 25, wherein the machine learning model is trained using on device training.
Aspect 27. A non-transitory computer-readable medium having stored thereon instructions that, when executed by at least one processor, cause the at least one processor to perform one or more of operations according to any of Aspects 14 to 26.
Aspect 28. An apparatus for wireless communication, the apparatus comprising one or more means for performing operations according to any of Aspects 14 to 26.

What is claimed is:

1. An apparatus for data processing, the apparatus comprising:
a processing system configured to:
process performance data associated with at least one processor to generate an embedding;
process, using a machine learning model, the embedding to determine a prediction associated with a task to be performed by the at least one processor; and
adjust performance parameters of the at least one processor based on the prediction.

2. The apparatus of claim 1, wherein the performance parameters include at least one of a clock frequency of the at least one processor, a voltage level of the at least one processor, or a cycle time period of the at least one processor.

3. The apparatus of claim 1, wherein, to adjust the performance parameters, the processing system is configured to scale the performance parameters based on the prediction.

4. The apparatus of claim 1, wherein the processing system is configured to:
process the performance data associated with the at least one processor to generate the embedding using an input layer and an embedding layer of the machine learning model.

5. The apparatus of claim 1, wherein the performance data includes at least one of a processor temperature, a clock frequency, a power management integrated circuit (PMIC) voltage, a processor voltage level, a processor bandwidth, a processor instructions per cycle, or a processor latency.

6. The apparatus of claim 1, wherein the processed performance data is quantized and normalized.

7. The apparatus of claim 1, wherein the embedding includes a set of values associated with one or more positions of tokens within the embedding.

8. The apparatus of claim 1, wherein the processing system is configured to:
process the performance data associated with the at least one processor to generate the embedding, wherein the processed performance data is sorted into levels based on performance data values and the performance data values are tokenized, normalized, and quantized based on the levels.

9. The apparatus of claim 1, wherein the machine learning model is a transformer.

10. The apparatus of claim 9, wherein the transformer is a large language model (LLM) using cross-attention of the performance parameters, wherein the performance parameters are associated with a current workload of the at least one processor.

11. The apparatus of claim 1, wherein the performance data includes a concatenation of data associated with a temperature of the at least one processor, a phase and frequency of the at least one processor, and a power management integrated circuit (PMIC) voltage.

12. The apparatus of claim 1, wherein the machine learning model is trained using hardware delay parameters associated with the at least one processor.

13. The apparatus of claim 1, wherein the machine learning model is trained using on device training.

14. A method for data processing, the method comprising:
processing performance data associated with at least one processor to generate an embedding;
processing, using a machine learning model, the embedding to determine a prediction associated with a task to be performed by the at least one processor; and
adjusting performance parameters of the at least one processor based on the prediction.

15. The method of claim 14, wherein the performance parameters include at least one of a clock frequency of the at least one processor, a voltage level of the at least one processor, or a cycle time period of the at least one processor.

16. The method of claim 14, wherein, to adjust the performance parameters, a processing system is configured to scale the performance parameters based on the prediction.

17. The method of claim 14, further comprising:
processing the performance data associated with the at least one processor to generate the embedding using an input layer and an embedding layer of the machine learning model.

18. The method of claim 14, wherein the performance data includes at least one of a processor temperature, a clock frequency, a power management integrated circuit (PMIC) voltage, a processor voltage level, a processor bandwidth, a processor instructions per cycle, or a processor latency.

19. The method of claim 14, wherein the processed performance data is quantized and normalized.

20. A non-transitory computer-readable medium having stored thereon instructions that, when executed by a processing system, cause the processing system to:
process performance data associated with at least one processor to generate an embedding;
process, using a machine learning model, the embedding to determine a prediction associated with a task to be performed by the at least one processor; and
adjust performance parameters of the at least one processor based on the prediction.
